(19) United States
(12) Patent Application Publication
(10) Pub. No.: US 2026/0350808 A1
(43) Pub. Date: Nov. 5, 2026

(54) IMAGE PROCESSING DEVICE, IMAGE PROCESSING SYSTEM, AND IMAGE PROCESSING METHOD

(71) Applicants: Hyundai Motor Company, Seoul (KR); Kia Corporation, Seoul (KR)

(72) Inventors: Changmo YANG, Gyeonggi-do (KR); Sungtai JANG, Gyeonggi-do (KR)

(21) Appl. No.: 19/118,580

(22) PCT Filed: Dec. 21, 2022
(86) PCT No.: PCT/KR2022/020943

§ 371 Date: Apr. 4, 2025

(30) Foreign Application Priority Data
Oct. 4, 2022 (KR) 10-2022-0126505

(51) Int. Cl. G06T 7/11; G06T 7/30

(52) U.S. Cl. CPC G06T 7/11; G06T 7/30; G06T 2207/20104; G06T 2207/30164

(57) ABSTRACT

An image processing device may include an exclusion region determining module configured to distinguish a vehicle body region and a component part region in a design data-based image, and determine a partial region including the component part region as an exclusion region, a reference image generating module configured to generate a reference image including a masking region masking the exclusion region in the design data-based image, a feature point search region defining module configured to define a feature point search region in an acquired image by using the reference image, and a feature point detecting module configured to detect a plurality of feature points in the feature point search region.

### TECHNICAL FIELD

The present disclosure relates to an image processing device, an image processing system, and an image processing method.

### BACKGROUND ART

Image-based inspection methods are used to check whether vehicle parts are assembled and their assembly status during vehicle manufacturing. For example, whether a vehicle component part has been assembled may be determined by using images photographed before and after the component part has been assembled. However, errors may occur between the acquired images due to different illumination environments or errors in the acquisition equipment, and to compensate for this, image alignment (or image matching) needs to be performed between the acquired images. If the image matching is not correctly performed between the acquired images, the image quality of the portion may deteriorate when recognizing and extracting a portion from the acquired image as a part or a part assembly portion. To perform image alignment in this way, feature point detection can be used.

### DISCLOSURE

### Technical Problem

The present disclosure attempts to provide an image processing device, an image processing system, and an image processing method, capable of improving the accuracy of the image matching by improving the performance of feature point detection used in image matching.

### Technical Solution

An image processing device may include an exclusion region determining module configured to distinguish a vehicle body region and a component part region in a design data-based image, and determine a partial region including the component part region as an exclusion region, a reference image generating module configured to generate a reference image including a masking region masking the exclusion region in the design data-based image, a feature point search region defining module configured to define a feature point search region in an acquired image by using the reference image, and a feature point detecting module configured to detect a plurality of feature points in the feature point search region.

The image processing device may further include a design data-based image generating module configured to generate the design data-based image by matching photographing coordinates corresponding to a photographed image provided from a camera configured to photograph the vehicle, with design data coordinates corresponding to the design data.

The exclusion region determining module may be configured to distinguish the vehicle body region and the component part region according to values assigned for each a vehicle body or a component part identification number in the design data.

The exclusion region may further include a background region distinguished from the vehicle body region and the component part region in the design data-based image.

The exclusion region may further include a user-designated region, which is a region designated by a user as having a significant change depending on an environment in the design data-based image.

The image processing device may further include an image matching module configured to perform an image matching with respect to the acquired image based on the plurality of feature points.

The image processing device may further include a transformation matrix generating module configured to generate a transformation matrix from a position deviation from the acquired image that was previously acquired, while performing the image matching, and an error analysis module configured to analyze whether a component value of the transformation matrix corresponds to a predefined error range.

The plurality of feature points may include a second feature point that is different from a first feature point and the first feature point, and the image matching module may be configured to perform the image matching with respect to the acquired image by using the second feature point, when the component value of the transformation matrix generated according to image matching using the first feature point is out of the error range.

The feature point search region defining module may be configured to change the feature point search region by increasing or decreasing an at least a portion of a boundary line of the feature point search region by pixel units, when the component value of the transformation matrix is out of the predefined error range, the feature point detecting module may be configured to detect a new feature point in the changed feature point search region, and the image matching module may be configured to perform the image matching with respect to the acquired image based on the new feature point.

An image processing system may include a mobile robot configured to photograph a vehicle at photographing coordinates determined in teaching provided in advance, a first image processing device provided with a first photographed image from the mobile robot, and configured to generate a reference image for the feature point search by using a design data-based image matched to the first photographed image, and a second image processing device provided with a second photographed image from the mobile robot, and configured to perform an image matching with respect to the second photographed image based on a feature point search region defined in the reference image.

The first image processing device may include an exclusion region determining module configured to distinguish a vehicle body region and a component part region in the design data-based image, and determine a partial region including the component part region as an exclusion region, and a reference image generating module configured to generate the reference image including a masking region masking the exclusion region in the design data-based image.

The exclusion region determining module may be configured to distinguish the vehicle body region and the component part region according to values assigned for each a vehicle body or a component part identification number in the design data.

The second image processing device may include a feature point search region defining module configured to define the feature point search region in the second photographed image by using the reference image, and a feature point detecting module configured to detect a plurality of feature points in the feature point search region.

The second image processing device may further include an image matching module configured to perform image matching with respect to the second photographed image based on the plurality of feature points, a transformation matrix generating module configured to generate a transformation matrix from position deviation from the second photographed image that was previously acquired, while performing the image matching, and an error analysis module configured to analyze whether a component value of the transformation matrix corresponds to a predefined error range.

The plurality of feature points may include a first feature point and a second feature point different from the first feature point, and the image matching module may be configured to perform the image matching with respect to the second photographed image by using the second feature point, when the component value of the transformation matrix generated according to image matching using the first feature point is out of the error range.

The feature point search region defining module may be configured to change the feature point search region by increasing or decreasing an at least a portion of a boundary line of the feature point search region by pixel units, when the component value of the transformation matrix is out of the predefined error range, the feature point detecting module may be configured to detect a new feature point in the changed feature point search region, and the image matching module may be configured to perform image matching with respect to the second photographed image based on the new feature point.

An image processing method may include distinguishing a vehicle body region and a component part region in a design data-based image, determining a partial region including the component part region as an exclusion region, generating a reference image including a masking region masking the exclusion region in the design data-based image, defining a feature point search region in an acquired image by using the reference image, and detecting a plurality of feature points in the feature point search region.

The image processing method may further include performing an image matching with respect to the acquired image based on the plurality of feature points, generating a transformation matrix from a position deviation from the acquired image that was previously acquired, while performing the image matching, and analyzing whether a component value of the transformation matrix corresponds to a predefined error range.

The plurality of feature points may include a first feature point and a second feature point different from the first feature point, and the image processing method may further include performing the image matching with respect to the acquired image by using the second feature point when the component value of the transformation matrix generated according to image matching using the first feature point is out of the error range.

The image processing method may further include changing the feature point search region by increasing or decreasing an at least a portion of a boundary line of the feature point search region by pixel units, when the component value of the transformation matrix is out of the predefined error range, detecting a new feature point in the changed feature point search region, and performing the image matching with respect to the acquired image based on the new feature point.

### Advantageous Effects

According to embodiments, by distinguishing a region in an image where there is relatively little change depending on the photographing environment (e.g., a vehicle body region) and a region where there is relatively much change (e.g., a component parts assembly region, a region sensitive to lighting changes, etc.), and extracting feature points from the region where there is relatively little change, the performance of feature point detection can be improved and the accuracy of image matching can be enhanced.

### DESCRIPTION OF THE DRAWINGS

FIG. 1 is a drawing for explaining a image processing system according to an embodiment.

FIG. 2 is a drawing for explaining a design data-based image that can be used in an image processing system according to embodiments.

FIG. 3 to FIG. 5 are drawings for explaining determining exclusion region in an image processing system according to embodiments.

FIG. 6 is a drawing for explaining a reference image that can be used in an image processing system according to embodiments.

FIG. 7 and FIG. 8 are drawings for explaining a feature point search region defined in the acquired image by using a reference image in an image processing system according to embodiments.

FIG. 9 is a drawing for explaining an image processing method according to an embodiment.

FIG. 10 is a drawing for explaining a image processing system according to an embodiment.

FIG. 11 and FIG. 12 are drawings for explaining an error range of image acquisition occurring due to errors of an acquisition equipment.

FIG. 13 and FIG. 14 are drawings for explaining a feature point detection in the case when the error range is exceeded.

FIG. 15 is a drawing for explaining an image processing method according to an embodiment.

FIG. 16 is a drawing for explaining a feature point detection in the case when the error range is exceeded.

FIG. 17 is a drawing for explaining an image processing method according to an embodiment.

FIG. 18 is a drawing for explaining an embodiment of a computing device for implementing an image processing device, an image processing system, and an image processing method according to embodiments.

### MODE FOR INVENTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

The terms “unit”, “part” or “portion”, “-er”, and “module” in the specification refer to a unit that processes at least one function or operation, which may be implemented by hardware, software, or a combination of hardware and software. In addition, at least a partial configuration or function of an image processing device, an image processing system, and an image processing method according to embodiments described below may be implemented as a program or software, and the program or software may be stored in a computer-readable medium.

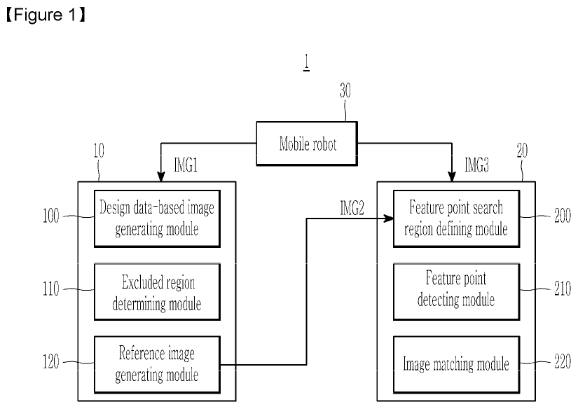

FIG. 1 is a drawing for explaining a image processing system according to an embodiment.

Referring to FIG. 1, an image processing system 1 according to an embodiment may include a first image processing device 10, a second image processing device 20 and a mobile robot 30.

The mobile robot 30 may be a robot that can understand the environment in an industrial site, move around, and assist or perform tasks on behalf of people. Unlike an automated guided vehicle (AGV) that relies on a predefined path, a mobile robot 30 is equipped with various types of sensors including cameras, computer vision sensors, voice recognition sensors, and lidar, and uses computing technologies such as artificial intelligence and machine learning to collect data about the environment and make decisions on its own, such as setting a path. The mobile robot 30 can be used in various production processes in robot-automated manufacturing plants for various industrial products, such as vehicles, for example. In the following embodiments, the mobile robot 30 may photograph the vehicle at photographing coordinates determined in teaching provided in advance.

The first image processing device 10 may generate a reference image IMG2 by using a photographed image IMG1 and a design data-based image. Here, the photographed image IMG1 is an image acquired by photographing at least a portion of the vehicle in advance, and the design data-based image is an image generated based on the design data (e.g., 3D cad data). Taking a door frame as an example, the photographed image IMG1 is, for example, a door frame image of the vehicle photographed by the mobile robot 30 in some photographing environments, and the design data-based image is, a door frame image rendered to match corresponding photographing environment (e.g., the photographing coordinates, the photographing angle, or the like), from the 3D cad data with respect to the door frame of the corresponding vehicle type.

The reference image IMG2 may be an image used to define a feature point search region on an acquired image IMG3. Here, the acquired image IMG3 may be an image photographed during the production process with respect to at least a portion of the vehicle, and the feature point search region may be a region in a certain image determined to search for the feature point to be used in image matching. That is, in the embodiments, the feature point search region may only include a region in a certain image where the performance of feature point detection is determined to be high, and exclude a region in a certain image where the performance of feature point detection is determined to be low. Taking the door frame as an example, the reference image IMG2 may enable a region where the performance of feature point detection is determined to be high (e.g., a region having relatively small change in the image according to the photographing environment) and a region where the performance of feature point detection is determined to be low (e.g., a region having relatively significant change in the image according to the photographing environment) to be distinguished on the acquired image IMG3 with respect to the door frame. The second image processing device 20 may define the feature point search region on the acquired image IMG3 by using the reference image IMG2, and may perform the image matching by detecting the feature point from it. In the present embodiment, it is illustrated that the photographed image IMG1 and the acquired image IMG3 is photographed by the mobile robot 30, but range of the present disclosure is not limited thereto.

The first image processing device 10 may, for example, be provided with the photographed image IMG1 from the mobile robot 30, generate the reference image IMG2 for the feature point search by using the design data-based image matched the photographed image IMG1, and include a design data-based image generating module 100, an exclusion region determining module 110 and a reference image generating module 120.

The design data-based image generating module 100 may generate the design data-based image by matching the photographing coordinates corresponding to the photographed image IMG1 provided from a camera (e.g., a camera installed in the mobile robot 30) photographing the vehicle, and the design data coordinates corresponding to the design data. For example, when the photographing coordinates of a camera photographing the door frame in a certain workspace may be coordinates x1, y1, and z1 on a first coordinate system, and the design data coordinates of an image rendered from the design data of the door frame is coordinates x2, y2, and x2 on a second coordinate system, the design data-based image may be generated by matching (or converting) the photographing coordinates and the design data coordinates in coordinates of the same coordinate system. For example, in subsequent processes, the design data-based image generated as such with respect to the door frame may match the size, region, angle, or the like, in the actually seen door frame, compared to the acquired image acquired by being photographed at coordinates x1, y1, and z1 on the first coordinate system with respect to a door frame of an actual vehicle. Of course, the method by which the design data-based image generating module 100 matches the photographed image IMG1 and the image rendered from the design data is not limited to the method described above.

The exclusion region determining module 110 may distinguish a vehicle body region and a component part region in the design data-based image in generated by the design data-based image generating module 100, and determine a partial region including the component part region as the exclusion region. Here, in setting the feature point search region, the exclusion region may be used to indicate a region where the performance of feature point detection is determined to be low and thereby required to be excluded. Specifically, as the exclusion region is determined in the exclusion region determining module 110, a masking region may be set based on these exclusion regions, and a work to include only the region where the performance of feature point detection is determined to be high in the feature point search region in the image acquired therefrom may be performed.

The exclusion region may include the component part region. The vehicle body region may include the vehicle body, and the component part region may include a component part (e.g., a cable) assembled to the vehicle body. However, since the component part may be manually assembled at an arbitrary time point by a worker according to a process sequence that is not concretely fixed, when the component part region is included in the feature point search region and the image matching with respect to the acquired images before and after the assembly of the corresponding component part is performed based on the feature point detected in a corresponding the component part region, the accuracy of the image matching cannot be ensured. As the component part region is included in the exclusion region, detecting a feature point having a high possibility of deteriorating the accuracy of the image matching may be prevented.

In some embodiments, the exclusion region determining module 110 may distinguish the vehicle body region and the component part region in the design data-based image automatically generated in the design data-based image generating module 100 by using the design data. Specifically, in the design data, various values may be assigned to the vehicle body or a component part identification number. For example, a first value (e.g., ‘0’) may be assigned to the design data corresponding to the identification number of the part corresponding to the vehicle body,, in order to represent that the corresponding part is the vehicle body, and a second value (e.g., ‘1’) may be assigned to the design data corresponding to the identification number of the part corresponding to the component part other than the vehicle body, in order to represent that the corresponding part is a component part. The exclusion region determining module 110 may automatically distinguish the vehicle body region and the component part region according to the values assigned as such in the design data for the vehicle body or the component part identification number.

In some embodiments, the exclusion region may further include a background region. The background region may include, for example, a region excluding a major subject (e.g., the door frame) on the acquired image IMG3 photographed by the mobile robot 30, and may include, for example, a region where another part distinguished from the major subject, internal facilities of the factory, the worker is photographed. When such a background region is included in the feature point search region and the image matching with respect to the acquired images is performed based on the feature point detected in a corresponding background region, the accuracy of the image matching cannot be ensured. As the background region is included in the exclusion region, detecting a feature point having a high possibility of deteriorating the accuracy of the image matching may be prevented.

In some embodiments, the exclusion region may further include a user-designated region. The user-designated region may be a region designated by a user as a region having a significant change depending on an environment in the design data-based image. For example, the user may designate a portion of the vehicle body where a reflection surface protrudes to have a high light reflection, as a region having a significant change in the design data-based image according to the illumination environments inside the factory. When such a user-designated region of a protruding portion is included in the feature point search region and the image matching with respect to the acquired images before and after the light reflection occurs based on the feature point detected in a corresponding user-designated region is performed, the accuracy of the image matching cannot be ensured. As the user-designated region is included in the exclusion region, detecting a feature point having a high possibility of deteriorating the accuracy of the image matching may be prevented.

The reference image generating module 120 may generate the reference image IMG2 including the masking region, which the design data-based image where the exclusion region determined by the exclusion region determining module 110 is masked. The masking region may be generated by combining the exclusion region. For example, depending on specific implementation purpose or environment, the masking region may include only the component part region, may include the component part region and the background region, may include the component part region and the user-designated region, or may include all of the component part, the background region, and the user-designated region. The generated reference image IMG2 may be transmitted to the second image processing device 20.

In some embodiments, the reference image generating module 120 may display the masking region by using binary values. For example, the reference image IMG2 may be an image of a predetermined size, and the masking region and other regions may be distinguished through binary values assigned to respective pixels composing the corresponding image. For example, a first binary value (e.g., ‘0’) may be assigned to the pixel corresponding to the masking region, and a second binary value (e.g., ‘1’) may be assigned to the pixels corresponding to other regions, while the representation scheme of the masking region is not limited to the method described above.

The second image processing device 20 may be, for example, provided with the photographed acquired image IMG3 from the mobile robot 30, may perform the image matching with respect to the acquired image IMG3 based on the feature point search region defined in the reference image IMG2, and may include the feature point search region defining module 200, a feature point detecting module 210 and an image matching module 220.

The feature point search region defining module 200 may define the feature point search region in the acquired image IMG3 by using the reference image IMG2 received from the reference image generating module 120. Specifically, the feature point search region defining module 200 may overlap the reference image IMG2 including the masking region on the acquired image IMG3, exclude a region covered by the masking region on the acquired image IMG3 from the feature point search region, and include a region that is not covered by the masking region on the acquired image IMG3 in the feature point search region.

In some embodiments, the reference image IMG2 may be generated at the same size as the acquired image IMG3 at the time point generated by the reference image generating module 120. In this case, the feature point search region defining module 200 may overlap the acquired image IMG3 and the reference image IMG2, without a separate resizing work.

In some embodiments, the sizes of the reference image IMG2 and the acquired image IMG3 received by the feature point search region defining module 200 may be different. In this case, the feature point search region defining module 200 may perform resizing so that the size of the reference image IMG2 matches the size of the acquired image IMG3, or perform resizing so that the acquired image IMG3 matches the size of the reference image IMG2 to the contrary, and then may overlap the acquired image IMG3 and the reference image IMG2. In addition, when needed, cropping, rotating, or the like, of the image may be selectively performed.

In some embodiments, the reference image IMG2 generated by the reference image generating module 120 may be stored in database, and when the new acquired image IMG3 has been generated, the feature point search region defining module 200 may acquire the reference image IMG2 corresponding to the acquired image IMG3 from the database. At this time, the reference image IMG2 stored in the database may be appropriately labeled for each searching depending on the acquired image IMG3.

The feature point detecting module 210 may detect a plurality of feature points in the feature point search region defined by the feature point search region defining module 200. The feature points detected in the feature point search region defined by the feature point search region defining module 200 may be feature points that may be referenced for accurate image matching even if the photographing environment has changed.

In some embodiments, the feature point detecting module 210 may perform correction of brightness and contrast in the feature point search region through histogram matching with respect to the acquired image IMG3, for adjustment so that the lighting similarity becomes high, and then detect the plurality of feature points. For example, based on the histogram value obtained in advance with respect to the feature point search region in connection with the photographed image IMG1 or the reference image IMG2, the histogram value is corrected in the feature point search region of the acquired image IMG3, and thereby the performance of the feature point detection may be further improved.

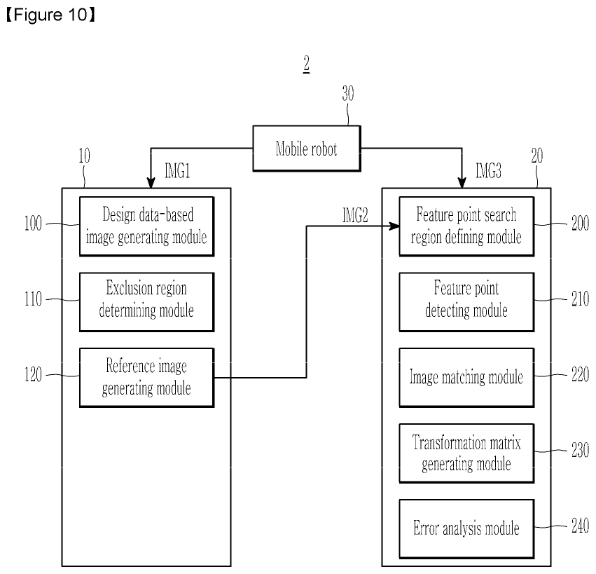

The image matching module 220 may perform the image matching with respect to the acquired image IMG3 based on the plurality of feature points detected by the feature point detecting module 210. When the image matching result is not out of an error range of an acquisition apparatus (e.g., the mobile robot 30), the image matching may be finished, and when the image matching result is out of the error range of the acquisition apparatus, the feature points may be re-selected to re-perform the image matching. The re-performing operation of the image matching according to the error range will be described later with reference to FIG. 10 to FIG. 17.

According to the present embodiment, by excluding a region having a relatively significant change in the image due to an environmental change such as an uncontrollable illumination, or a region where there exists an image phase change between when the component part is manually assembled and when the component part is not assembled from the feature point search region, the detection rate and accuracy of the feature points for the image matching between the acquired images may be improved, and thereby the performance of detecting the feature point used in the image matching may be improved. In addition, since the exclusion region in the feature point search region of the acquired image may be automatically determined based on the design data (e.g., 3D cad data), the feature point search region may be set effectively and efficiently within a short period. Accordingly, in an industrial site where it is difficult to control the working environments such as illumination, the performance of the image matching may be improved and the image acquisition and matching process may be improved to have an automated scheme, which enables an effective operation of the vision system while reducing the number of persons such as vision experts and engineers in the manufacturing factory.

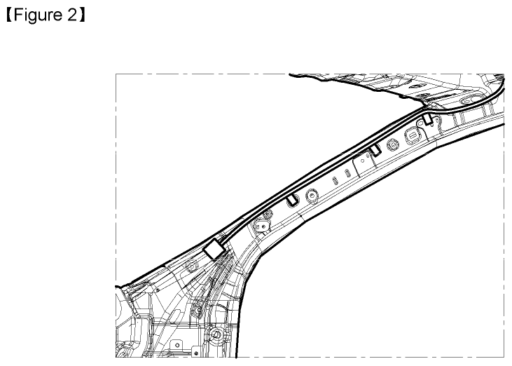

Hereinafter, referring to FIG. 2 to FIG. 8, an operation of the image processing system 1 described above will be described, using a pillar supporting between the door and the ceiling of the vehicle as an example.

FIG. 2 is a drawing for explaining the design data-based image that can be used in an image processing system according to embodiments.

Referring to FIG. 2, the design data-based pillar image generated based on the 3D cad data with respect to the pillar of the vehicle is a pillar image rendered to match the photographing environment (e.g., the photographing coordinates, the photographing angle, or the like, in the coordinate system related to the mobile robot 30) of the pillar image photographed by the mobile robot 30 in advance. For example, the design data-based pillar image of FIG. 2 may be generated by matching the photographing coordinates corresponding to the photographed pillar image provided from the mobile robot 30 photographing the pillar, and the design data coordinates based on the 3D cad data with respect to the pillar in coordinates of the same coordinate system.

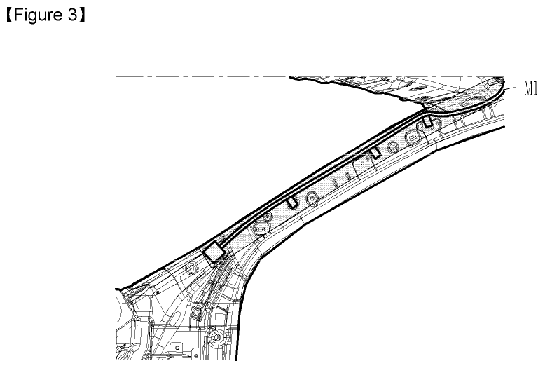

FIG. 3 to FIG. 5 are drawings for explaining determining exclusion region in an image processing system according to embodiments.

Referring to FIG. 3, the component part region M1 distinguished from the vehicle body region in the design data-based pillar image of FIG. 2 is represented. The component part assembled to the pillar, for example, since the cable may be manually assembled at an arbitrary time point by a worker according to a process sequence that is not concretely fixed, when the component part region M1 including the cable is included in the feature point search region, and the image matching with respect to the acquired images before and after the cable is assembled is performed based on the feature point detected in the component part region M1, the accuracy of the image matching cannot be ensured. Accordingly, the component part region M1 may be included in the exclusion region.

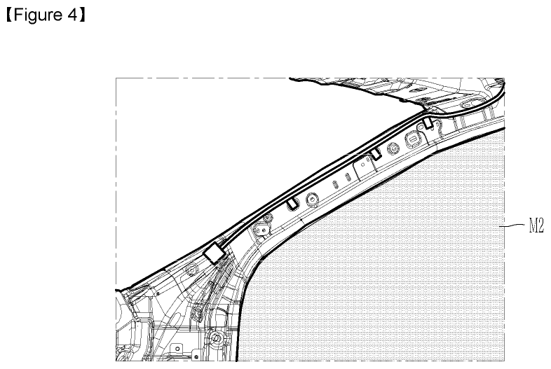

Referring to FIG. 4, a background region M2 distinguished from the vehicle body region in the design data-based pillar image of FIG. 2 is represented. The background region M2 in which another part distinguished from the major subject pillar, internal facilities of the factory, or the workers are captured may be included in the feature point search region, and when the image matching with respect to the acquired images is performed based on the feature point detected in the background region M2 with respect to the acquired images having different backgrounds, the accuracy of the image matching cannot be ensured. Accordingly, the background region M2 may be included in the exclusion region.

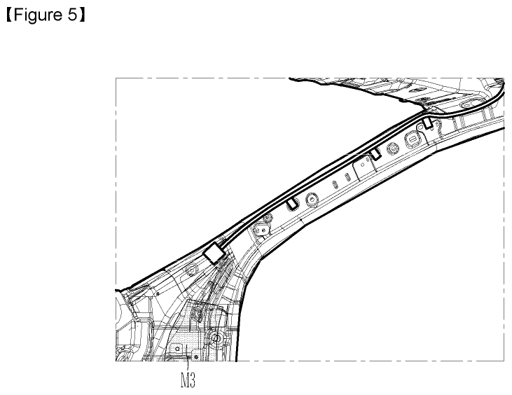

Referring to FIG. 5, a user-designated region M3 distinguished from the vehicle body region in the design data-based pillar image of FIG. 2 is represented. The user may designate a portion of the vehicle body where a reflection surface protrudes to have a high light reflection, which is a region having a significant change in the design data-based image according to the illumination environments inside the factory, as the user-designated region M3, the user-designated region M3 may be included in the feature point search region, and when the image matching with respect to the acquired images that have a strong light reflection and does not have a light reflection is performed based on the feature point detected in the user-designated region M3, the accuracy of the image matching cannot be ensured. Accordingly, the user-designated region M3 may be included in the exclusion region.

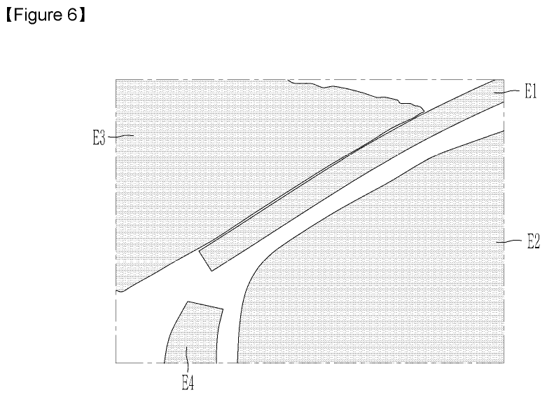

FIG. 6 is a drawing for explaining a reference image that can be used in an image processing system according to embodiments.

Referring to FIG. 6, a reference pillar image may include a masking region E1 corresponding to the component part region M1 illustrated in FIG. 3 to FIG. 5, masking regions E2 and E3 corresponding to the background region M2, and a masking region E4 corresponding to the user-designated region M3. In the present embodiment, it is illustrated that the reference pillar image includes all of the masking regions E1, E2, E3, and E4, but the depending on specific implementation purpose or environment, may include only some masking regions of the masking regions E1, E2, E3, and E4.

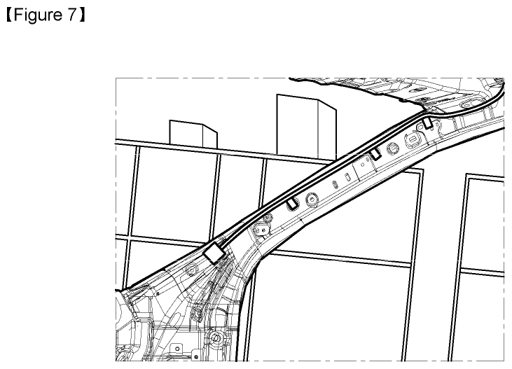

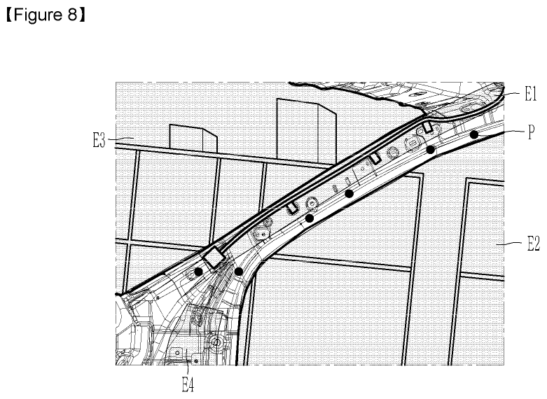

FIG. 7 and FIG. 8 are drawings for explaining the feature point search region defined in the acquired image by using a reference image in an image processing system according to embodiments.

Referring to FIG. 7, the illustrated acquired pillar image is an image photographed by the mobile robot 30 during the production process. Since the photographing was performed during the production process, it may be seen that the interior of the factory behind the pillar was also photographed.

Referring to FIG. 8, the reference pillar image including the masking regions E1, E2, E3, and E4 may be overlapped on the acquired pillar image, a region covered by the masking regions E1, E2, E3, and E4 on the acquired pillar image may be excluded from the feature point search region, and a region that is not covered by the masking regions E1, E2, E3, and E4 on the acquired pillar image may be included in the feature point search region. The plurality of feature points P may be detected in in the feature point search region defined as such.

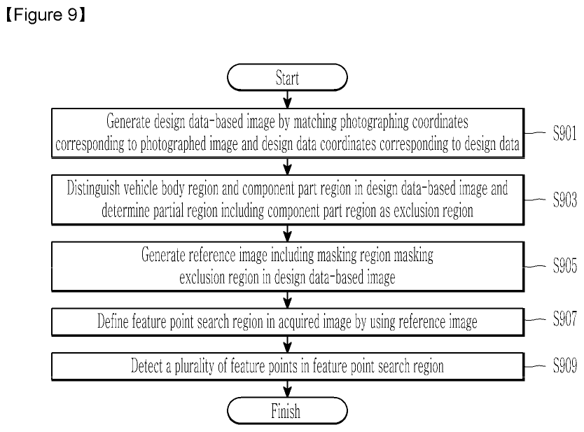

FIG. 9 is a drawing for explaining an image processing method according to an embodiment.

Referring to FIG. 9, an image processing method according to an embodiment may, at step S901, generate the design data-based image by matching the photographing coordinate corresponding to the photographed image and the design data coordinates corresponding to the design data, and at step S903, distinguish the vehicle body region and the component part region in the design data-based image, and determine a partial region including the component part region as the exclusion region. In addition, at step S905, the method may generate a reference image including the masking region masking the exclusion region in the design data-based image, and at step S907, may define the feature point search region in the acquired image by using the reference image. In addition, at step S909, the method may detect the plurality of feature points in the feature point search region.

For further details of an image processing method according to the present embodiment, the description in connection with FIG. 1 to FIG. 8 may be referred to, and redundant description will not be included herein.

FIG. 10 is a drawing for explaining a image processing system according to an embodiment.

Referring to FIG. 10, an image processing system 2 according to an embodiment may include the first image processing device 10, the second image processing device 20 and the mobile robot 30. Difference from the image processing system 1 described above in connection with FIG. 1 may lie in that the second image processing device 20 further includes a transformation matrix generating module 230 and an error analysis module 240.

While performing the image matching, the transformation matrix generating module 230 may generate the transformation matrix from a position deviation from the acquired image that was previously acquired. The transformation matrix may be generated when calculating position deviation from the existing image after acquiring the image, and may include information on movement (i.e., translation), scale, shear, rotation, and tilt. For example, the transformation matrix can be defined as a 3×3 matrix as follows:
   |Sx Shy E|
   |Shx Sy F|
   |Tx Ty 1|

Here, Tx and Ty may represent displacements along x-axis and y-axis, respectively, and Sx and Sy may represent scale factors along x-axis and y-axis, respectively. Shx and Shy may represent shear factors along x-axis and y-axis, respectively. E and F may be factors affecting the vanishing point with respect to tilt. In some embodiments, the transformation matrix may be configured to include cos(q), sin(q), −sin(q), cos(q) values for a rotation angle q about a certain center instead of Tx, Ty, Sx, Sy, Shx, Shy, E and F.

The error analysis module 240 may analyze whether a component value of the transformation matrix corresponds to a predefined error range. Here, the predefined error range may include an error range with respect to each image acquisition equipment, for example, a photographing position of the mobile robot 30. The mobile robot 30 may repeatedly perform the image acquisition at various photographing positions, and may calculate the error range for each photographing position, with respect to each of various components of the transformation matrix.

If the component value of the transformation matrix generated according to the image matching is out of the error range, the image matching module 220 may re-select the feature points and re-perform the image matching.

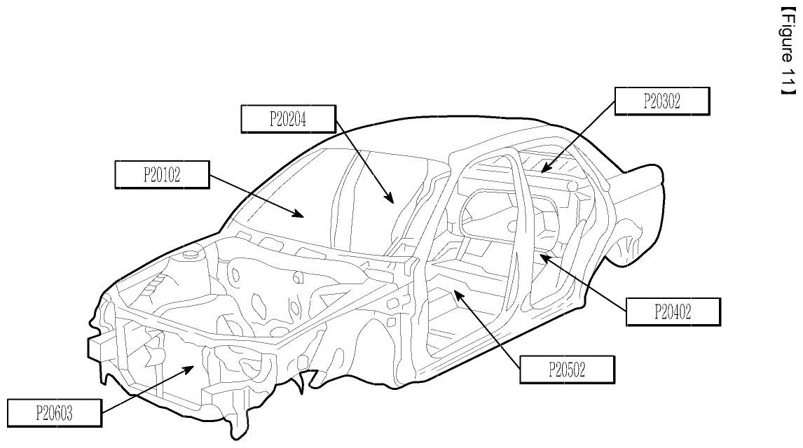

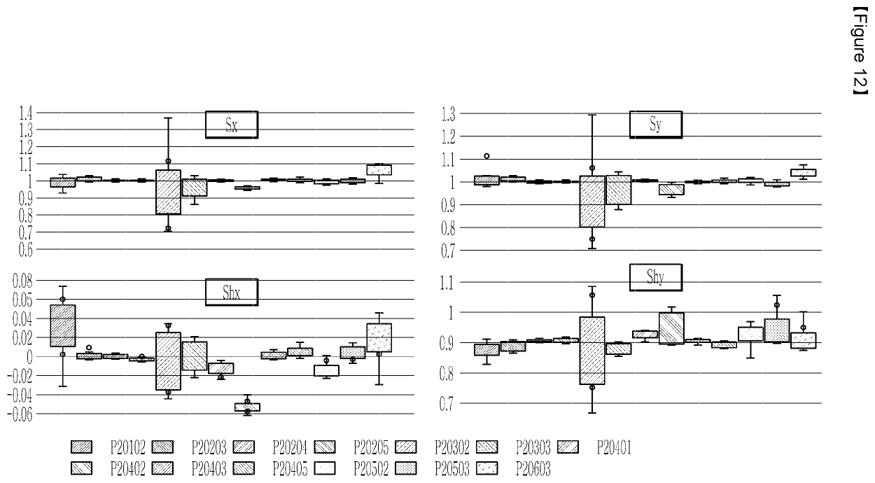

FIG. 11 and FIG. 12 are drawings for explaining an error range of image acquisition occurring due to errors of an acquisition equipment.

Referring to FIG. 11, the mobile robot 30 may repeatedly perform the image acquisition at various photographing positions with respect to the vehicle. For example, the mobile robot 30 may perform the image acquisition at a first position P20102, a second position P20204, a third position P20302, a fourth position P20402, a fifth position P20502, and a sixth position P20603, and referring to FIG. 12, with respect to each of various components of the transformation matrix, the error range calculated for each photographing position may be known. Specifically, with respect to each Sx, Sy, Shx, Shy component of the transformation matrix, it may be seen that the error range is calculated with respect to each of the position P20102 to the position P20603. For example, in the case of an Sx component of the transformation matrix generated while performing the image matching, the error analysis module 240 may analyze whether the value of the Sx component corresponds to the error range of about 0.8 to about 1.05 in connection with the third position P20302, and when the value of the Sx component of the transformation matrix generated while performing the image matching is out of the error range of about 0.8 to about 1.05, the image matching module 220 may re-select the feature points and re-perform the image matching.

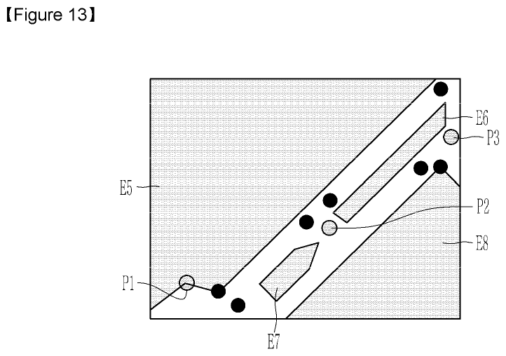

Hereinafter, embodiments that re-perform the image matching will be described in detail with reference to FIG. 13 to FIG. 17.

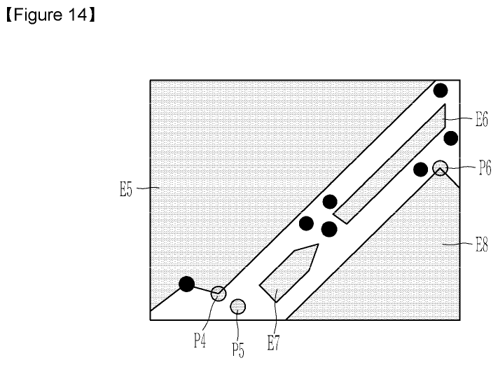

FIG. 13 and FIG. 14 are drawings for explaining a feature point detection in the case when the error range is exceeded.

Referring to FIG. 13, the acquired image may overlap with the reference image including masking regions E5, E6, E7, and E8, a region covered by the masking regions E5, E6, E7, and E8 on the acquired image may be excluded from the feature point search region, and a region that is not covered by the masking regions E5, E6, E7, and E8 on the acquired image may be included in the feature point search region.

The feature point detecting module 210 may detect n (n is a natural number, for example, 10) feature points in the feature point search region shown in FIG. 13, and the image matching module 220 may perform the image matching with respect to the acquired image based on m (m is a natural number smaller than n, for example, 3) feature points P1, P2, and P3 primarily selected among n the plurality of feature points. In addition, the transformation matrix generating module 230 may generate the transformation matrix from the position deviation from the acquired image that was previously acquired, while performing the image matching, and the error analysis module 240 may analyze whether the component value of the transformation matrix corresponds to the predefined error range.

Referring to FIG. 14, when the component value of the transformation matrix generated according to the image matching using m feature points P1, P2, and P3 is out of the error range, the image matching module 220 may secondarily re-select m feature points P4, P5, and P6 from among n feature points and re-perform the image matching. Thereafter, while re-performing the image matching, the transformation matrix generating module 230 may secondarily generate the transformation matrix from the position deviation from the acquired image that was previously acquired, and the error analysis module 240 may analyze whether the component value of the transformation matrix corresponds to the predefined error range.

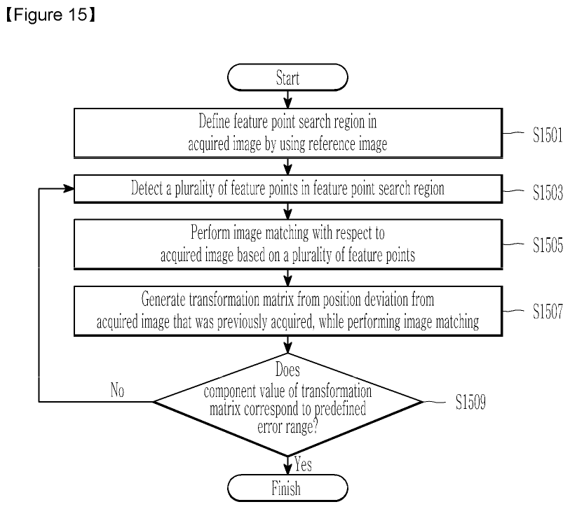

FIG. 15 is a drawing for explaining an image processing method according to an embodiment.

Referring to FIG. 15, an image processing method according to an embodiment may, at step S1501, define the feature point search region in the acquired image by using the reference image, and at step S1503, detect the plurality of feature points including a first feature point in the feature point search region. In addition, at step S1505, the method may perform the image matching with respect to the acquired image based on the plurality of feature points including the first feature point, and at step S1507, may generate the transformation matrix from the position deviation from the acquired image that was previously acquired while performing the image matching. In addition, at step S1509, the method may determine whether the component value of the transformation matrix corresponds to the predefined error range.

When it is determined that the component value of the transformation matrix corresponds to the predefined error range, the image matching may be successfully terminated, and when it is determined that the component value of the transformation matrix is out of the predefined error range, the method may proceed to the step S1503, to re-select the plurality of feature points including a second feature point different from the first feature point. Thereafter, at the step S1505, the image matching with respect to the acquired image may be performed based on the plurality of feature points including the second feature point.

For further details of an image processing method according to the present embodiment, the description in connection with FIG. 1 to FIG. 14 may be referred to, and redundant description will not be included herein.

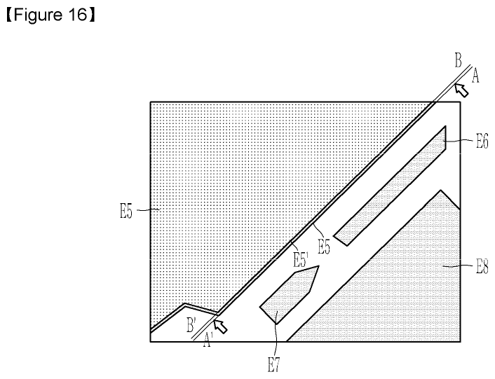

FIG. 16 is a drawing for explaining a feature point detection in the case when the error range is exceeded.

Referring to FIG. 16, the acquired image may overlap with the reference image including the masking regions E5, E6, E7, and E8, a region covered by the masking regions E5, E6, E7, and E8 on the acquired image may be excluded from the feature point search region, and a region that is not covered by the masking regions E5, E6, E7, and E8 on the acquired image may be included in the feature point search region.

The feature point detecting module 210 may detect the plurality of feature points in the feature point search region shown in FIG. 16, and the image matching module 220 may perform the image matching with respect to the acquired image based on the plurality of feature points. In addition, the transformation matrix generating module 230 may generate the transformation matrix from the position deviation from the acquired image that was previously acquired, while performing the image matching, and the error analysis module 240 may analyze whether the component value of the transformation matrix corresponds to the predefined error range.

When the component value of the transformation matrix is out of the predefined error range, the feature point search region defining module 200 may increase or decrease an at least a portion A-A′ of the boundary line of the feature point search region by pixel units, to change it to the feature point search region including a new boundary line B-B′. Thereafter, the feature point detecting module 210 may detect a new feature point in the changed the feature point search region, and the image matching module 220 may perform the image matching with respect to the acquired image based on the new feature point.

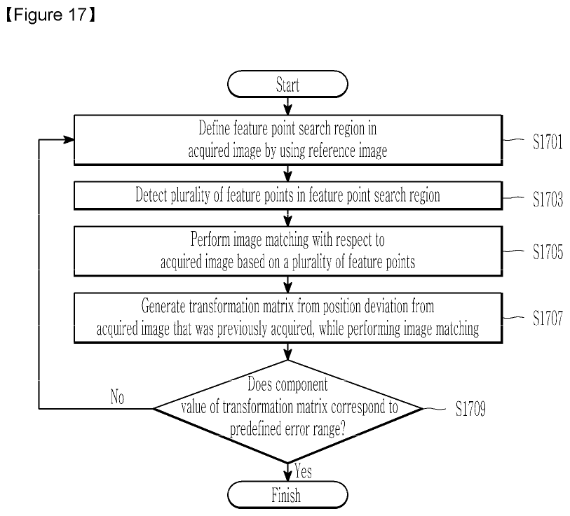

FIG. 17 is a drawing for explaining an image processing method according to an embodiment.

Referring to FIG. 17, an image processing method according to an embodiment may, at step S1701, define the feature point search region including a first boundary line in the acquired image by using the reference image, and at step S1703, may detect the plurality of feature points in the feature point search region. In addition, at step S1705, the method may perform the image matching with respect to the acquired image based on the plurality of feature points, and at step S1707, may generate the transformation matrix from the position deviation from the acquired image that was previously acquired, while performing the image matching. In addition, at step S1709, the method may determine whether the component value of the transformation matrix corresponds to the predefined error range.

When it is determined that the component value of the transformation matrix corresponds to the predefined error range, the image matching may be successfully terminated, and when it is determined that the component value of the transformation matrix is out of the predefined error range, the method may proceed to the step S1701, to define the feature point search region including a new second boundary line which is obtained by increasing or decreasing the first boundary line by pixel units. Thereafter, at the step S1703 and the step S1705, the new feature point may be detected in the changed the feature point search region, and the image matching with respect to the acquired image may be performed based on the new feature point.

For further details of an image processing method according to the present embodiment, the description in connection with FIG. 1 to FIG. 12 and FIG. 16 may be referred to, and redundant description will not be included herein.

In some embodiments, when the error range is exceeded, the embodiment described above in connection with FIG. 13 to FIG. 15 and the embodiment described above in connection with FIG. 16 and FIG. 17 may be implemented in combination.

For example, the feature point detecting module 210 may detect n (n is a natural number, for example, 10) feature points in the feature point search region including the first boundary line, and the image matching module 220 may perform the image matching with respect to the acquired image based on m (m is a natural number smaller than n, for example, 3) feature points primarily selected from among the plurality of n feature points. In addition, the transformation matrix generating module 230 may generate the transformation matrix from the position deviation from the acquired image that was previously acquired, while performing the image matching, and the error analysis module 240 may analyze whether the component value of the transformation matrix corresponds to the predefined error range.

When the component value of the transformation matrix generated according to the image matching using m feature points is out of the error range, the image matching module 220 may secondarily re-select m feature points from among n feature points and re-perform the image matching.

When the component value of the transformation matrix is still out of the error range even after the image matching module 220 has repeated the process of re-selecting m feature points from among n feature points and re-perform the image matching by a predetermined number of times (e.g., 5 times) or more, the feature point search region defining module 200 may define the feature point search region including the new second boundary line which is obtained by increasing or decreasing the first boundary line by pixel units. Thereafter, n feature points may be detected again in the changed feature point search region, and the process of performing the image matching with respect to the acquired image based on m feature points primarily selected from among the plurality of n feature points may be repeated.

In addition, in some embodiments, the first boundary line may be set so that an increase or decrease by a predetermined pixel value (e.g., 5 pixels) is possible, and when the increase or decrease value has reached the predetermined pixel value, an increase or decrease by pixel units may be performed with respect to a boundary line different from the first boundary line in the feature point search region including the first boundary line.

According to an embodiment described above, by excluding a region having a relatively significant change in the image due to an environmental change such as an uncontrollable illumination, or a region where there exists an image phase change between when the component part is manually assembled and when the component part is not assembled from the feature point search region, the detection rate and accuracy of the feature points for the image matching between the acquired images may be improved, and thereby the performance of detecting the feature point used in the image matching may be improved. In addition, since the exclusion region in the feature point search region of the acquired image may be automatically determined based on the design data (e.g., 3D cad data), the feature point search region may be set effectively and efficiently within a short period. Accordingly, in an industrial site where it is difficult to control the working environments such as illumination, the performance of the image matching may be improved and the image acquisition and matching process may be improved to have an automated scheme, which enables an effective operation of the vision system while reducing the number of persons such as vision experts and engineers in the manufacturing factory.

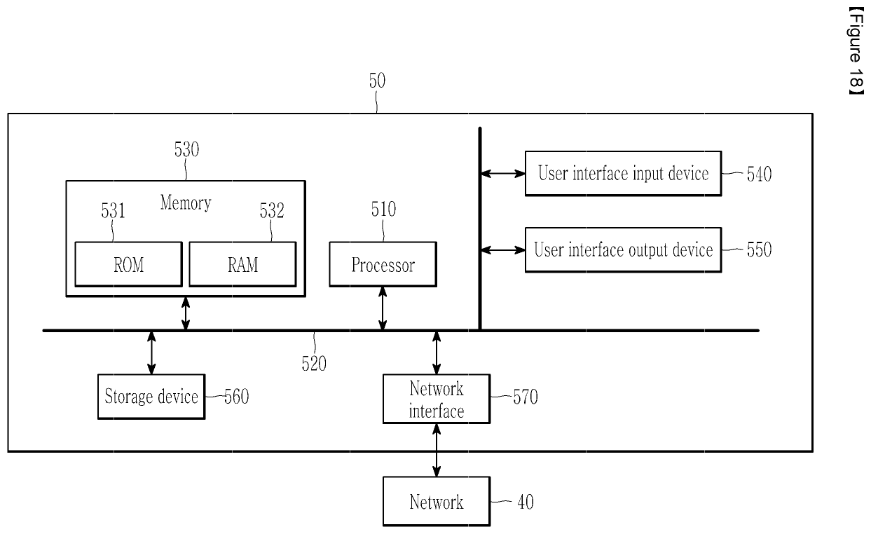

FIG. 18 is a drawing for explaining an embodiment of a computing device for implementing an image processing device, an image processing system, and an image processing method according to embodiments.

Referring to FIG. 18, an image processing device, an image processing system, and an image processing method according to embodiments may be implemented by using a computing device 500.

The computing device 500 may include at least one of a processor 510, a memory 530, a user interface input device 540, a user interface output device 550 and a storage device 560 that communicate with each other through a bus 520. The computing device 500 may include a network interface 570 electrically connected to a network 40. The network interface 570 may send or receive signals to and from other entities through the network 40.

The processor 510 may be implemented in various types, such as a micro controller unit (MCU), an application processor (AP), a central processing unit (CPU), a graphic processing unit (GPU), a neural processing unit (NPU), and the like, may be any semiconductor device configured to execute instructions stored in the memory 530 or the storage device 560. The processor 510 may be configured to implement function and methods described above with reference to FIG. 1 to FIG. 17.

The memory 530 and the storage device 560 may include various types of volatile or non-volatile storage media. For example, the memory may include a read-only memory (ROM) 531 and a random access memory (RAM) 532. In the present embodiment, the memory 530 may be positioned in an interior or exterior of the processor 510, and the memory 530 may be connected to the processor 510 through various known means.

In some exemplary embodiments, at least some of the configurations or functions of the image processing device, the image processing system, and the image processing method according to the exemplary embodiments may be implemented by programs or software executed by the computing device 500, and the programs or software may be stored in a computer-readable medium.

In some embodiments, at least partial configuration or function of an image processing device, an image processing system, and an image processing method according to embodiments may be implemented as a hardware that can be electrically connected to the computing device 500.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of an appended claims.

1. An image processing device, comprising:
an exclusion region determining module configured to distinguish a vehicle body region and a component part region in a design data-based image, and determine a partial region comprising the component part region as an exclusion region;
a reference image generating module configured to generate a reference image comprising a masking region masking the exclusion region in the design data-based image;
a feature point search region defining module configured to define a feature point search region in an acquired image by using the reference image; and
a feature point detecting module configured to detect a plurality of feature points in the feature point search region.

2. The image processing device of claim 1, further comprising a design data-based image generating module configured to generate the design data-based image by matching photographing coordinates corresponding to a photographed image provided from a camera configured to photograph the vehicle, with design data coordinates corresponding to the design data.

3. The image processing device of claim 1, wherein the exclusion region determining module is configured to distinguish the vehicle body region and the component part region according to values assigned for each a vehicle body or a component part identification number in the design data.

4. The image processing device of claim 1, wherein the exclusion region further comprises a background region distinguished from the vehicle body region and the component part region in the design data-based image.

5. The image processing device of claim 1, wherein the exclusion region further comprises a user-designated region, which is a region designated by a user as having a significant change depending on an environment in the design data-based image.

6. The image processing device of claim 1, further comprising an image matching module configured to perform an image matching with respect to the acquired image based on the plurality of feature points.

7. The image processing device of claim 6, further comprising:
a transformation matrix generating module configured to generate a transformation matrix from a position deviation from the acquired image that was previously acquired, while performing the image matching; and
an error analysis module configured to analyze whether a component value of the transformation matrix corresponds to a predefined error range.

8. The image processing device of claim 7, wherein:
the plurality of feature points comprises a second feature point that is different from a first feature point and the first feature point; and
the image matching module is configured to perform the image matching with respect to the acquired image by using the second feature point, when the component value of the transformation matrix generated according to image matching using the first feature point is out of the error range.

9. The image processing device of claim 7, wherein:
the feature point search region defining module is configured to change the feature point search region by increasing or decreasing an at least a portion of a boundary line of the feature point search region by pixel units, when the component value of the transformation matrix is out of the predefined error range;
the feature point detecting module is configured to detect a new feature point in the changed feature point search region; and
the image matching module is configured to perform the image matching with respect to the acquired image based on the new feature point.

10. An image processing system, comprising:
a mobile robot configured to photograph a vehicle at photographing coordinates determined in teaching provided in advance;
a first image processing device provided with a first photographed image from the mobile robot, and configured to generate a reference image for the feature point search by using a design data-based image matched to the first photographed image; and
a second image processing device provided with a second photographed image from the mobile robot, and configured to perform an image matching with respect to the second photographed image based on a feature point search region defined in the reference image.

11. The image processing system of claim 10, wherein the first image processing device comprises:
an exclusion region determining module configured to distinguish a vehicle body region and a component part region in the design data-based image, and determine a partial region comprising the component part region as an exclusion region; and
a reference image generating module configured to generate the reference image comprising a masking region masking the exclusion region in the design data-based image.

12. The image processing system of claim 11, wherein the exclusion region determining module is configured to distinguish the vehicle body region and the component part region according to values assigned for each a vehicle body or a component part identification number in the design data.

13. The image processing system of claim 11, wherein the second image processing device comprises:
a feature point search region defining module configured to define the feature point search region in the second photographed image by using the reference image; and
a feature point detecting module configured to detect a plurality of feature points in the feature point search region.

14. The image processing system of claim 13, wherein the second image processing device further comprises:
an image matching module configured to perform image matching with respect to the second photographed image based on the plurality of feature points;
a transformation matrix generating module configured to generate a transformation matrix from position deviation from the second photographed image that was previously acquired, while performing the image matching; and
an error analysis module configured to analyze whether a component value of the transformation matrix corresponds to a predefined error range.

15. The image processing system of claim 14, wherein:
the plurality of feature points comprises a first feature point and a second feature point different from the first feature point; and
the image matching module is configured to perform the image matching with respect to the second photographed image by using the second feature point, when the component value of the transformation matrix generated according to image matching using the first feature point is out of the error range.

16. The image processing system of claim 14, wherein:
the feature point search region defining module is configured to change the feature point search region by increasing or decreasing an at least a portion of a boundary line of the feature point search region by pixel units, when the component value of the transformation matrix is out of the predefined error range;
the feature point detecting module is configured to detect a new feature point in the changed feature point search region; and
the image matching module is configured to perform image matching with respect to the second photographed image based on the new feature point.

17. An image processing method, comprising:
distinguishing a vehicle body region and a component part region in a design data-based image;
determining a partial region comprising the component part region as an exclusion region;
generating a reference image comprising a masking region masking the exclusion region in the design data-based image;
defining a feature point search region in an acquired image by using the reference image; and
detecting a plurality of feature points in the feature point search region.

18. The image processing method of claim 17, further comprising:
performing an image matching with respect to the acquired image based on the plurality of feature points;
generating a transformation matrix from a position deviation from the acquired image that was previously acquired, while performing the image matching; and
analyzing whether a component value of the transformation matrix corresponds to a predefined error range.

18. The image processing method of claim 18, wherein:
the plurality of feature points comprises a first feature point and a second feature point different from the first feature point; and
the image processing method further comprises performing the image matching with respect to the acquired image by using the second feature point when the component value of the transformation matrix generated according to image matching using the first feature point is out of the error range.

20. The image processing method of claim 18, further comprising:
changing the feature point search region by increasing or decreasing an at least a portion of a boundary line of the feature point search region by pixel units, when the component value of the transformation matrix is out of the predefined error range;
detecting a new feature point in the changed feature point search region; and
performing the image matching with respect to the acquired image based on the new feature point.
